(19) United States
(12) Patent Application Publication
(10) Pub. No.: US 2022/0343190 A1
(43) Pub. Date: Oct. 27, 2022

(54) SYSTEMS FOR AUTOMATIC DETECTION, RATING AND RECOMMENDATION OF ENTITY RECORDS AND METHODS OF USE THEREOF

(71) Applicant: Capital One Services, LLC, Mclean, VA (US)

(72) Inventors: Jennifer Kwok, New York, NY (US); Cruz Vargas, Denver, CO (US); Viraj Chaudhary, Katy, TX (US)

(21) Appl. No.: 17/237,959

(22) Filed: Apr. 22, 2021

(51) Int. Cl. G06N 5/04; G06N 20/00; G06F 16/28; G06F 16/2457; G06Q 30/02; G06F 3/0482

(52) U.S. Cl. CPC G06N 5/04; G06N 20/00; G06F 16/285; G06F 16/24578; G06Q 30/0201; G06F 3/0482

(57) ABSTRACT

Systems and methods of the present disclosure include computer systems for improving data discovery and recommendation. To do so, activity records associated with multiple entities are received, including activity data for electronic activities with the entities. An entity classification model engine including an entity classification model is utilized to predict at least one entity-type classification classifying at least one first entity of the entities as a first entity type. A first plurality of entity-related activity characteristics representing an activity pattern is associated with the at least one first entity and is extracted from the activity data. An entity rating model engine comprising an entity rating model is utilized to predict at least one entity rating prediction for the at least one entity based at least in part on the activity pattern, and an entity rating interface is generated comprising the at least one entity rating prediction interface element.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in drawings that form a part of this document: Copyright, Capital One Service, LLC, All Rights Reserved.

### FIELD OF TECHNOLOGY

The present disclosure generally relates to computer-based systems for automatic detection, rating and recommendation of entity records and methods thereof.

BACKGROUND OF TECHNOLOGY

Typically, entity discovery, rating and recommendation systems require explicit identification of entities, such through the use of tags, metadata, and/or other labels. However, in many instances, such labelling has not been performed. As a result, many entities may not be discoverable, and thus cannot be rated or recommended to users.

SUMMARY OF DESCRIBED SUBJECT MATTER

In some embodiments, the present disclosure provides an exemplary technically improved computer-based method that includes at least the following steps of receiving, by at least one processor, activity records associated with a plurality of entities; where the activity records include activity data for electronic activities with the plurality of entities; utilizing, by the at least one processor, an entity classification model engine to predict at least one entity-type classification classifying at least one first entity of the plurality of entities as a first entity type; where the entity classification model engine includes an entity classification model that includes a plurality of classification parameters trained based on a plurality of annotated training activity records; extracting, by the at least one processor, a first plurality of entity-related activity characteristics associated with the at least one first entity from the activity data; where the first plurality of entity-related activity characteristics represents a first entity-related activity pattern of activities across the activity data; utilizing, by the at least one processor, an entity rating model engine, including an entity rating model, to predict at least one entity rating prediction for the at least one entity based at least in part on the entity-related activity pattern; where the entity rating model engine includes a plurality of trained rating parameters trained based on at least one historical entity rating prediction for the plurality of entities; generating, by the at least one processor, an entity rating interface including the at least one entity rating prediction interface element for the at least one entity; where the entity rating interface includes: i) at least one first interface programmed element that enables a user to define at least one entity rating prediction modification so as cause the at least one processor to modify the at least one entity rating prediction to obtain at least one updated entity rating prediction, and ii) at least one second interface programmed element that displays the at least one updated entity rating prediction; and causing to display, by the at least one processor, the entity rating interface on a display of at least one computing device associated with at least one user.

In some embodiments, the present disclosure provides an exemplary technically improved computer-based method that includes at least the following steps of receiving, by at least one processor via an entity rating interface, a user selection of an entity rating prediction modification for an entity rating prediction interface element of at least one entity; where the entity rating interface includes: i) at least one first interface programmed element that enables a user to define the at least one entity rating prediction modification so as cause the at least one processor to modify at least one entity rating prediction to obtain at least one updated entity rating prediction, and ii) display the at least one updated entity rating prediction; extracting, by the at least one processor, entity-related activity characteristics associated with the at least one entity from activity records associated with the at least one entity; where the activity records include activity data for electronic activities associated with the at least one entity; where the entity-related activity characteristics include entity-related activity pattern of activities across the activity data; training, by the at least one processor, plurality of trained rating parameters of an entity rating model engine based on a difference between the entity-related activity pattern and the at least one entity rating prediction modification; utilizing, by the at least one processor, an entity rating model engine to predict at least one entity rating prediction for the at least one entity based at least in part on the entity-related activity pattern; where the entity rating model engine includes plurality of trained rating parameters trained based on historical entity rating predictions for a plurality of entities; updating, by the at least one processor, the entity rating interface including the at least one entity rating prediction for the at least one entity; and causing to display, by the at least one processor, the entity rating interface on a display of at least one computing device associated with at least one user.

In some embodiments, the present disclosure provides an exemplary technically improved computer-based system that includes at least the following components of at least one processor in communication with at least one non-transitory computer readable medium including software instructions. The software instructions, when executed, cause the at least one processor to perform steps to: receive activity records associated with a plurality of entities; where the activity records include activity data for electronic activities with the plurality of entities; utilize an entity classification model engine to predict at least one entity-type classification classifying at least one entity of the plurality of entities as a first entity type; where the entity classification model engine includes a plurality of classification parameters trained based on plurality of annotated training activity records; extract entity-related activity characteristics associated with the at least one entity from the activity data; where the entity-related activity characteristics represent an entity-related activity pattern of activities across the activity data; utilize an entity rating model engine to predict at least one entity rating prediction for the at least one entity based at least in part on the entity-related activity pattern; where the entity rating model engine includes plurality of trained rating parameters trained based on historical entity rating predictions for the plurality of entities; generate an entity rating interface including the at least one entity rating prediction for the at least one entity; where the entity rating interface is configured to: i) enable a user to define at least one entity rating prediction modification so as cause the at least one processor to modify the at least one entity rating prediction to obtain at least one updated entity rating prediction, and ii) display the at least one updated entity rating prediction; and cause to display the entity rating interface on a display of at least one computing device associated with at least one user.

Embodiments of the present disclosure as described above may further include receiving, by the at least one processor, enhanced activity data associated with the activity data of the activity records; and where the enhanced activity data is provided by an activity data enrichment service;

Embodiments of the present disclosure as described above may further include where the entity-related activity characteristics include the entity-related activity pattern of activities associated with the activity data and the enhanced activity data.

Embodiments of the present disclosure as described above may further include where the activity records include transaction authorization request messages.

Embodiments of the present disclosure as described above may further include where the first entity type includes a physical goods supplier.

Embodiments of the present disclosure as described above may further include where the entity-related activity pattern of activities of the activity data associated with the physical goods supplier includes: i) a repurchase rate by each second entity of a plurality of second entities that purchase from the physical goods supplier, ii) a seasonality of purchases by each second entity of the plurality of second entities that purchase from the physical goods supplier, iii) a transaction volume by each second entity of the plurality of second entities that purchase from the physical goods supplier, and iv) a type of goods by each second entity of the plurality of second entities that purchase from the physical goods supplier.

Embodiments of the present disclosure as described above may further include determining, by the at least one processor, a category code associated with the at least one entity; and utilizing, by the at least one processor, the entity rating model engine to predict the at least one entity rating prediction for the at least one entity based at least in part on the entity-related activity pattern and the category code.

Embodiments of the present disclosure as described above may further include receiving, by the at least one processor, a user selection of the at least one entity rating prediction modification for the at least one entity to obtain the at least one updated entity rating prediction; and training, by the at least one processor, the plurality of trained rating parameters of the entity rating model engine based on a difference between the at least one entity rating prediction and the at least one updated entity rating prediction.

Embodiments of the present disclosure as described above may further include updating, by the at least one processor, the entity rating interface to represent the at least one updated entity rating prediction.

Embodiments of the present disclosure as described above may further include receiving, by the at least one processor, a category code associated with a second entity; and utilizing, by the at least one processor, the entity rating model engine to predict, for the second entity, the at least one entity rating prediction of the at least one entity based at least in part on the entity-related activity pattern and the category code so as to customize the at least one entity rating prediction of the at least one entity for the category code of the second entity.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIGS. 1-7 show one or more schematic flow diagrams, certain computer-based architectures, and/or screenshots of various specialized graphical user interfaces which are illustrative of some exemplary aspects of at least some embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

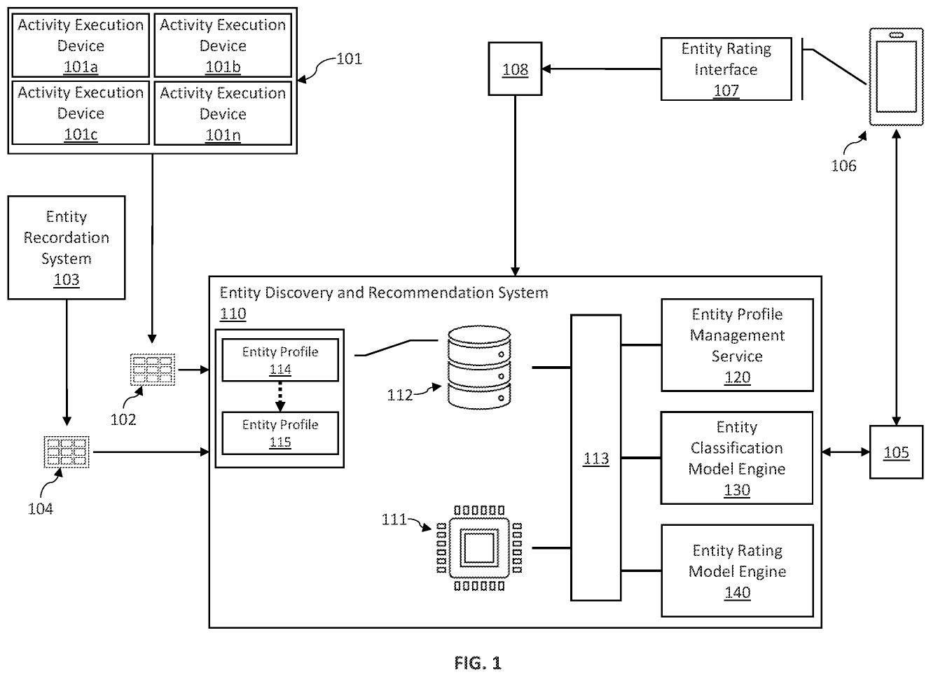

FIGS. 1 through 7 illustrate systems and methods of record resolution, entity discovery and automated entity rating and recommendations. The following embodiments provide technical solutions and technical improvements that overcome technical problems, drawbacks and/or deficiencies in the technical fields involving inefficient and incomplete entity records limiting the ability to automatically perform entity recognition, rating and recommendation. As explained in more detail, below, technical solutions and technical improvements herein include aspects of improved resolution of data entries with entity records to build entity profiles for automated entity recognition, including entity type recognition, entity ratings based on the data entries, and entity recommendations based on the entity ratings and entity types. Based on such technical features, further technical benefits become available to users and operators of these systems and methods. Moreover, various practical applications of the disclosed technology are also described, which provide further practical benefits to users and operators that are also new and useful improvements in the art.

FIG. 1 is a block diagram of an exemplary system for automated entity discovery, rating and recommendation in accordance with one or more embodiments of the present disclosure.

In some embodiments, an entity discovery and recommendation system 110 utilizes activity records 102 and entity records 104 to characterize and categorize entities for improved discovery and recognition. Based on the characterization of activity records 102 and the categorization of the entities, the entity discovery and recommendation system 110 may use machine learning based approaches to automatically predict ratings for each entity and make recommendations to users regarding the entities. Thus, the entity discovery and recommendation system 110 may solve technological deficiencies related to entity records 104 that do not explicitly categorize the entities and have not previously been rated by users, thus enabling new functionalities for rating and recommending entities to users according to entity type and entity-related activities.

In some embodiments, the activity records 102 may be produced or otherwise received from an activity execution network 101. In some embodiments, the activity execution network 101 may include one or more activity execution devices including, e.g., activity execution device 101a, activity execution device 101b, activity execution device 101c through activity execution device 101n.

In some embodiments, the activity execution device may include any computing device from electronic activities are performed or executed, such as, e.g., a terminal, personal computer or mobile computing device for performing Internet-based and application-based activities (e.g., account logins, account information changes, online purchases, instant message communications, social media posts, among others and combinations thereof).

In some embodiments, the activity execution device may include a physical terminal for performing electronic transactions, such as, e.g., a point-of-sale device, automated teller machine (ATM) or other device. As a result of a user executing electronic activities via the activity execution device, data entries may be produced for entry into the user's account. For example, the activity execution device may produce an electronic activity record.

Accordingly, in some embodiments, the activity records 102 may be associated with corresponding electronic activities executed using one or more the activity execution device 101a, activity execution device 101b, activity execution device 101c through activity execution device 101n. In some embodiments, each activity records 102 may include data related to the associated electronic activity and any entities associated therewith. Thus, the activity records 102 may include data items such as, e.g., e.g., a user identifier associated with each record, an entity identifier associated with each record, a second entity identifier identifying a second entity associated with each record, an activity type identifier, an activity value or activity quantity, a time data item, a location data item, a date data item, a device type or device identifier associated with the activity execution network 101, an activity description, or other attributes representing characteristics of each record.

For example, in some embodiments, the electronic activity record may include a transaction-related activity, such as a transaction authorization request message or transaction authorization request record (e.g., transaction authorization request, posted transaction, etc.). In such an example, the data items may include, e.g., a transaction value, a transaction type, an account identifier or a user identifier or both, a merchant identifier, a transaction authorization date, a transaction post date, a transaction location, an execution device (e.g., point-of-sale device, Internet payment, etc.) among other transaction data and combinations thereof.

In some embodiments, each activity record 102 may be related to entities of a particular type, or of one or various types of entities. An entity type may include, e.g., a person, a charity, a governmental organization, a political body, a corporate entity, a partnership, a cooperative, a physical service, a software service, a computer system, a publisher (e.g., of media or software), or any other entity types. The entity type may also include types within a given type, such as, e.g., an office, department, division, market segment, categorization within a type, or any other type within a type.

However, in some embodiments, the activity record 102 may not provide data regarding the type or type-within-a-type (e.g., categorization or classification) of the associated entities. Accordingly, the entity discovery and recommendation system 110 may infer or predict an entity type for each entity associated with each activity record 102 such entities may be rated and recommended in reference to other entities of the same type.

In some embodiments, the entity discovery and recommendation system 110 may also receive entity records 104 from, e.g., an entity recordation system 103. In some embodiments, the entity recordation system 103 may aggregate and manage data regarding entities, including, e.g., entity behaviors and patterns with respect to historical electronic activities. In some embodiments the entity recordation system 103 may also provide an activity data enrichment service to generate enhanced activity data based on historical entity-related electronic activities, including, e.g., statistically enhanced activity data, including electronic activity frequency, seasonality, quantity or value totals, averages, medians, distributions or other characterizations, among other statistical enhancements to historical electronic activity data. For example, the entity recordation system 103 may include, e.g., entity records 104 for merchants with data including, e.g., average sale quantity, average sale value, sale frequency, average monthly sale value, average quarterly sale value, average yearly sale value, merchant category code (MCC), operating locations, among other merchant activity data.

In some embodiments, the entity discovery and recommendation system 110 may receive the entity records 104 and the activity records 102 a build entity profile 114 through entity profile 115 which may be used to classify each entity and rate and recommend each entity according to entity-related activity data. Thus, the entity discovery and recommendation system 110 may include hardware and software components including, e.g., computing device hardware and software, cloud or server hardware and software, or a combination thereof.

In some embodiments, the entity discovery and recommendation system 110 may include hardware components such as a processor 111, which may include local or remote processing components. In some embodiments, the processor 111 may include any type of data processing capacity, such as a hardware logic circuit, for example an application specific integrated circuit (ASIC) and a programmable logic, or such as a computing device, for example, a microcomputer or microcontroller that include a programmable microprocessor. In some embodiments, the processor 111 may include data-processing capacity provided by the microprocessor. In some embodiments, the microprocessor may include memory, processing, interface resources, controllers, and counters. In some embodiments, the microprocessor may also include one or more programs stored in memory.

Similarly, the entity discovery and recommendation system 110 may include storage 112, such as local hard-drive, solid-state drive, flash drive, database or other local storage, or remote storage such as a server, mainframe, database or cloud provided storage solution, or any other non-transitory computer readable medium. In some embodiments, the term “database” refers to an organized collection of data, stored, accessed or both electronically from a computer system. The database may include a database model formed by one or more formal design and modeling techniques. The database model may include, e.g., a navigational database, a hierarchical database, a network database, a graph database, an object database, a relational database, an object-relational database, an entity-relationship database, an enhanced entity-relationship database, a document database, an entity-attribute-value database, a star schema database, or any other suitable database model and combinations thereof. For example, the database may include database technology such as, e.g., a centralized or distributed database, cloud storage platform, decentralized system, server or server system, among other storage systems. In some embodiments, the database may, additionally or alternatively, include one or more data storage devices such as, e.g., a hard drive, solid-state drive, flash drive, or other suitable storage device. In some embodiments, the database may, additionally or alternatively, include one or more temporary storage devices such as, e.g., a random-access memory, cache, buffer, or other suitable memory device, or any other data storage solution and combinations thereof.

Depending on the database model, one or more database query languages may be employed to retrieve data from the database. Examples of database query languages may include: JSONiq, LDAP, Object Query Language (OQL), Object Constraint Language (OCL), PTXL, QUEL, SPARQL, SQL, XQuery, Cypher, DMX, FQL, Contextual Query Language (CQL), AQL, among suitable database query languages.

The database may include one or more software, one or more hardware, or a combination of one or more software and one or more hardware components forming a database management system (DBMS) that interacts with users, applications, and the database itself to capture and analyze the data. The DBMS software additionally encompasses the core facilities provided to administer the database. The combination of the database, the DBMS and the associated applications may be referred to as a “database system”.

In some embodiments, the entity discovery and recommendation system 110 may implement computer engines for creation and management of entity profile 114 through entity profile 115, classification of entities based on entity records 104 and activity records 102, and entity rating prediction for the entities. In some embodiments, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Herein, the term “application programming interface” or “API” refers to a computing interface that defines interactions between multiple software intermediaries. An “application programming interface” or “API” defines the kinds of calls or requests that can be made, how to make the calls, the data formats that should be used, the conventions to follow, among other requirements and constraints. An “application programming interface” or “API” can be entirely custom, specific to a component, or designed based on an industry-standard to ensure interoperability to enable modular programming through information hiding, allowing users to use the interface independently of the implementation.

In some embodiments, to determine the errors, the entity discovery and recommendation system 110 may include computer engines including, e.g., an entity profile management service 120. In some embodiments, the entity profile management service 120 may ingest the entity records 104 and activity records 102, extract entity-related activity data and entity-related activity patterns and build entity profile 114 through entity profile 115 to record the entity-related activity and entity-related activity patterns for each entity. In order to implement the entity profile management service 120, the entity profile management service 120 may include one or more computer engines that may include software components, hardware components, or a combination thereof. For example, each computer engine may include a dedicated processor and storage. However, in some embodiments, the computer engines share hardware resources, including the processor 111 and storage 112 of the entity discovery and recommendation system 110 via, e.g., a bus 113. Thus, the entity profile management service 120 may include a memory including software and software instructions, such as, e.g. machine learning models and/or logic for implementing the security tiers for controlled automated tiered confidential information sharing.

In some embodiments, to determine the errors, the entity discovery and recommendation system 110 may include computer engines including, e.g., an entity classification model engine 130. In some embodiments, the entity classification model engine 130 may ingest the activity records 102, the entity-related activity and/or the entity-related activity patterns for each entity according to each entity profile 114 through entity profile 115 to determine a categorization or type of each entity. In order to implement the entity profile management service 120, the entity classification model engine 130 may include one or more computer engines that may include software components, hardware components, or a combination thereof. For example, each computer engine may include a dedicated processor and storage. However, in some embodiments, the computer engines share hardware resources, including the processor 111 and storage 112 of the entity discovery and recommendation system 110 via, e.g., a bus 113. Thus, the entity classification model engine 130 may include a memory including software and software instructions, such as, e.g. machine learning models and/or logic for implementing the security tiers for controlled automated tiered confidential information sharing.

In some embodiments, to determine the errors, the entity discovery and recommendation system 110 may include computer engines including, e.g., an entity rating model engine 140. In some embodiments, the entity rating model engine 140 may ingest the entity-related activity and/or the entity-related activity patterns for each entity according to each entity profile 114 through entity profile 115 and the type of each entity to determine a rating of each entity relative to each other entity. Using the rating, the entity rating model engine 140 may also produce a recommendation to a user for a recommended entity of a given type. In order to implement the entity rating model engine 140, the entity rating model engine 140 may include one or more computer engines that may include software components, hardware components, or a combination thereof. For example, each computer engine may include a dedicated processor and storage. However, in some embodiments, the computer engines share hardware resources, including the processor 111 and storage 112 of the entity discovery and recommendation system 110 via, e.g., a bus 113. Thus, the entity rating model engine 140 may include a memory including software and software instructions, such as, e.g. machine learning models and/or logic for implementing the security tiers for controlled automated tiered confidential information sharing.

In some embodiments, the entity profile management service 120 may receive the activity records 102 and the entity records 104 and perform record resolution process to match the activity records 102 to the entity records 104 of the associated entities. Where an activity record 102 is associated with multiple entities, the activity records 102 may be linked to each entity record 104 of the multiple associated entities.

In some embodiments, the entity profile management service 120 may utilize any suitable resolution technique to resolve the activity records 102 with the entity records 104. For example, the entity profile management service 120 may produce matches of particular activity records 102 with particular entity records 104 according to similarity of entity identifiers and other entity-related information represented in each. For example, entity-related information may include, e.g., entity identifier, entity location, entity description, among others.

In some embodiments, the resolution technique may group according to similarity including, e.g., machine learning-based clustering, blocking, heuristic searching, iterative comparison of each activity record 102 to each entity record 104, among other techniques. In some embodiments, data entries may be matched according to a measure of similarity of individual or combinations of attributes represented in the data entries. In some embodiments, the measure of similarity may include, e.g., an exact match or a predetermined similarity score according to, e.g., Jaccard similarity, Jaro-Winkler similarity, Cosine similarity, Euclidean similarity, Overlap similarity, Pearson similarity, Approximate Nearest Neighbors, K-Nearest Neighbors, among other similarity measure. The predetermined similarity score may be any suitable similarity score according to the type of electronic activity to identify a measured attribute of any two data entries as the same.

In some embodiments, similarity may be measured between each individual attribute separately, and the respective similarity scores summed, averaged, or otherwise combined to produce a measure of similarity of two data entries. In some embodiments, the similarity may instead or in addition be measured for a combination of the device identifier, device type identifier and location identifier. For example, a hash or group key may be generated by combining the device identifier, device type identifier and location identifier. The hash may include a hash function that takes as input each attribute or a subset of attributes of a particular record. The group key may be produced by creating a single string, list, or value from combining each of, e.g., a string, list or value representing each individual attribute of the particular record. The similarity between two data entries may then be measured as the similarity between the associated hashes and/or group keys. The measured similarity may then be compared against the predetermined similarity score to determine candidate data entries that are candidates as matching to each other.

In some embodiments, once activity records 102 are matched to an associated entity record 104, the entity profile management service 120 may build or modify an entity profile 114 through entity profile 115 associated with the entity of the associated entity record 104 with the activity records 102. In some embodiments, the entity profile management service 120 may, e.g., query the storage 112 for an entity profile 114 through entity profile 115 using the entity identifier of the entity record 104. However, any suitable technique for identifying the entity profile 114 through entity profile 115 may be employed.

In some embodiments, where an entity profile 114 through entity profile 115 exists for the entity (e.g., where the storage 112 returns an entity profile 114 through entity profile 115 in response to the query), the entity profile management service 120 may modify the entity profile 114 through entity profile 115 by appending the activity records 102. Where an entity profile 114 through entity profile 115 is not found, the entity profile management service 120 may generate a new entity profile 114 through entity profile 115 for the entity of the associated entity record 104 and append the activity records 102 thereto.

In some embodiments, the entity profile management service 120 may additionally enter into the entity profile 114 entity-related activity characteristics extracted from the activity records 102, the entity record 104 or both. In some embodiments, entity-related activity characteristics can include, e.g., activity locations, activity location range, activity dates, activity date range, activity times, average activity times, average activity time range, among other characteristics and combinations thereof. In some embodiments, the entity-related activity characteristics may include, e.g., entity-related activity patterns determined from patterns in the activity records 102 for a given entity. For example, the entity profile management service 120 may determine, e.g., an activity rate or frequency, an activity repeat rate including a rate of a second entity repeating an electronic activity with the entity of the given entity record 102, seasonality in electronic activity rate, frequency, quantity or other metric, total activity value or quantity or total activity value or quantity in a given time period, one or more types of activities and relative rates of activities for each type, among other entity-related activity patterns. In some embodiments, the entity-related activity characteristics and/or the entity-related activity patterns may be present in the associated entity records 104 or may be determined by the entity profile management service 120 or any combination thereof.

In some embodiments, the entity classification model engine 130 may utilize the entity profile 114 through 115 of a given entity to determine a classification or entity type (hereinafter “entity-type classification”) for the given entity. In some embodiments, the entity classification model engine 130 may employ a machine learning model, such as a machine learning classifier to predict the entity-type classification according to the associated activity records 102 and/or entity-related activity characteristics and patterns in the entity profile 114 through entity profile 115.

In some embodiments, the entity classification model engine 130 may be configured to utilize one or more exemplary AI/machine learning techniques chosen from, but not limited to, decision trees, boosting, support-vector machines, neural networks, nearest neighbor algorithms, Naive Bayes, bagging, random forests, and the like. In some embodiments and, optionally, in combination of any embodiment described above or below, an exemplary neutral network technique may be one of, without limitation, feedforward neural network, radial basis function network, recurrent neural network, convolutional network (e.g., U-net) or other suitable network. In some embodiments and, optionally, in combination of any embodiment described above or below, an exemplary implementation of Neural Network may be executed as follows:

i) define Neural Network architecture/model,
ii) transfer the input data to the exemplary neural network model,
iii) train the exemplary model incrementally,
iv) determine the accuracy for a specific number of timesteps,
v) apply the exemplary trained model to process the newly-received input data,
vi) optionally and in parallel, continue to train the exemplary trained model with a predetermined periodicity.

In some embodiments and, optionally, in combination of any embodiment described above or below, the exemplary trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the exemplary trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the exemplary aggregation function may be a mathematical function that combines (e.g., sum, product, etc.) input signals to the node. In some embodiments and, optionally, in combination of any embodiment described above or below, an output of the exemplary aggregation function may be used as input to the exemplary activation function. In some embodiments and, optionally, in combination of any embodiment described above or below, the bias may be a constant value or function that may be used by the aggregation function and/or the activation function to make the node more or less likely to be activated.

In some embodiments, because the entity classification model engine 130 predicts an entity-type classification, the entity classification model engine 130 may be configured to utilize a classifier for machine learning-based classification, such as, e.g., classification decision trees, classification support-vector machines, classification neural networks (such as a convolutional neural network), nearest neighbor algorithms, classification bagging, classification random forests, and the like. In some embodiments, the entity classification model engine 130 may employ supervised learning using annotated training activity records to train classification parameters to generate the entity-type classification, unsupervised learning such as clustering or adversarial models, or semi-supervised learning.

In some embodiments, the entity classification model engine 130 may append the entity-type classification for a particular entity to the associated entity profile 114 through entity profile 115. In some embodiments, the entity rating model engine 140 may ingest the entity profile 114 through entity profile 115 and/or the entity-type classification to generate a rating prediction for a rating of the particular entity relative to other entities of the same entity-type classification.

In some embodiments, the entity rating model engine 140 may ingest or extract the entity-related activity characteristics of a particular entity. In some embodiments, the entity rating model engine 140 may utilize the activity records 102 and entity record 104 of the particular entity to determine the entity-related activity characteristics, however, in some embodiments, the entity-related activity characteristics may be present in the entity profile 114 through entity profile 115 due to the entity profile management service 120 having determined the entity-related activity characteristics.

In some embodiments, performance of an entity in executing electronic activities can be inferred from the entity-related activity characteristics. For example, changes to entity-related activity patterns such as increases in activity volumes, quantities or values can signal high performance, high quality and/or high satisfaction rates for executing electronic activities with other entities. Similarly, entity-related activity patterns such as high repeat rates of electronic activities with particular other entities can signal high performance, high quality and/or high satisfaction rates for executing electronic activities with the particular other entities.

However, in some embodiments, other entity-related activity characteristics may influence activity volumes, activity quantities, activity values and repeat rates, such as seasonality, the type or category of the other entities, and other externalities. For example, the other entity may have a particular type or category that affects the electronic activities of the activity records 102. Thus, a category code signifying the type or category of the other entity may signal the performance, the quality and/or the satisfaction rates for executing electronic activities with the other entities having the same category code.

Accordingly, the entity rating model engine 140 may ingest as input features the entity-related activity characteristics, e.g., from the associated entity profile 114 through entity profile 115, to formulate an entity rating prediction 105 of a particular entity. In some embodiments, the entity rating prediction 105 indicates a numerical or qualitative indication of the performance, the quality and/or the satisfaction rates for executing electronic activities with the other entities, such as, e.g., a ranking on a scale from, e.g., 1 to 5, 1 to 10, 1 to 20, 1 to 100, or any other suitable rating, or a rating classification, such as, e.g., low/medium/high, bad/fair/good/better/best, below average/average/above average/exceptional, or any other subjective rating.

In some embodiments, the entity rating model engine 140 may customize the entity rating prediction 105 for a user requesting the entity rating prediction 105, e.g., from computing device 106. In some embodiments, the user may be associated with the other entity or a second entity that engages in electronic activities with the particular entity for which the entity rating prediction 105 is requested. Accordingly, the category code of the other entity or second entity associated with the user may be included with the input features to inform the prediction. As a result, the entity rating prediction 105 may be personalized to the user.

In some embodiments, the entity rating model engine 140 may be configured to utilize any suitable machine learning technique, such as those described above. In some embodiments, the entity rating model engine 140 may include regression or classifier models depending on whether the entity rating model engine 140 is configured for numerical or subjective ratings. In some embodiments, a classifier model may be employed to classify each entity according to a rating category including, e.g., a whole number from, e.g., 1 to 5, 1 to 10, 1 to 20, 1 to 100, or any other suitable numerical scale, or a qualitative term including, e.g., low/medium/high, bad/fair/good/better/best, below average/average/above average/exceptional, or any other qualitative scale. In some embodiments, the classifier may include, e.g., a clustering model for unsupervised learning. Accordingly, the model may automatically adjust to the performance levels of other entities for efficient and dynamic rating prediction and personalization. In some embodiments, the entity rating prediction 105 may be appended to the entity profile 114 through entity profile 115 of the associated entity, and/or provide the entity rating prediction 105 directly to a user at the computing device 106.

In some embodiments, the entity discovery and recommendation system 110 may return the entity rating prediction 105 to the computing device 106, e.g., in response to a request from the computing device 106. In some embodiments, a user may interact with an entity rating interface 107 to request, e.g., an entity recommendation for a particular entity type. In response, in some embodiments, the entity discovery and recommendation system 110 may utilize the entity profile 114 through entity profile 115 to identify entities having the particular type according to the entity type classification from the entity classification model engine 130, and return as the entity rating prediction 105, e.g., a list of one or more of the highest rated entities of the particular type according to the entity rating predictions by the entity rating model engine 140. In some embodiments, the entity discovery and recommendation system 110 may return the entity rating prediction 105 predicted by the entity rating model engine 140 along with entity identifiers in the list of the one or more of the highest rated entities of the particular type.

In some embodiments, the entity discovery and recommendation system 110 may return, in response to a request by the user via the entity rating interface 107 for a rating prediction for a particular entity, the entity rating prediction 105 from the entity rating model engine 140. Accordingly, the user may select an entity, or an entity type and be quickly and efficiently provided with rating predictions for the selected entity or a recommended set of the highest performing entities for the selected type, thus improving entity discovery, entity rating, entity recommendation and other functionalities with dynamic and personalized predictions.

In some embodiments, the user may respond to the entity rating prediction 105 to, e.g., modify the entity rating prediction 105. In some embodiments, the entity rating interface 107 may include options for user selection that enable the user to select a correction, adjustment, modification or confirmation of the entity rating prediction 105, such as, e.g., user selection of a different rating value or classification, user selection of a confirmation, user inaction including not selecting a correction, adjustment or modification, or other form of modification. In some embodiments, the modification may be returned to the entity discovery and recommendation system 110 as an entity rating prediction modification 108. In some embodiments, the entity discovery and recommendation system 110 may utilize the entity rating prediction modification 108 to update and display the entity rating prediction for the entity, and/or to train the entity rating model engine 140 according to a difference between the entity rating prediction 105 and the entity rating prediction modification 108.

In some embodiments, as more users modify the entity rating prediction for a particular entity, an entity performance rating may be formed in the entity profile 114 through entity profile 115 that includes the entity rating prediction 105 replaced with a statistical aggregation of the modifications to the entity rating. In some embodiments, rather than replacing the entity rating prediction 105, the modifications to the entity rating may be used to augment the entity rating prediction 105, e.g., using a statistical aggregation of the modifications to the entity rating prediction and the entity rating prediction 105 to produce the entity performance rating. In some embodiments, the entity rating interface 107 may display the entity performance rating using, e.g., the entity rating prediction 105 for the requesting user aggregated with the modifications to the entity rating predictions for previous requesting users.

An example to illustrate aspects of some embodiments may include a user associated with a merchant requesting ratings and recommendations for physical goods suppliers with which to stock the merchant's stores. However, other scenarios may employ the entity discovery and recommendation system 110.

In some embodiments, the merchant may interact with the entity rating interface 107 to search for physical goods suppliers for the merchant's business. To select a best physical goods supplier, the merchant may request a recommendation for a physical goods supplier or set of physical goods suppliers and supply performance ratings associated with each physical goods supplier.

In some embodiments, the entity discovery and recommendation system 110 may collect physical goods supplier records (e.g., entity records 104) from a business directory that aggregates and records supplier data, such as, e.g., a merchant data enrichment service or other directory. The entity discovery and recommendation system 110 may also collect transactions (e.g., activity records 102) associated with each physical goods supplier from a payment network (e.g., activity execution network 101). Using the physical goods supplier records and the transactions, the entity discovery and recommendation system 110 may build entity profile 114 through entity profile 115 including physical goods supplier transaction profiles that characterize transaction data and transaction patterns, such as, e.g., transaction volume, transaction revenue, transaction type, physical goods of each transaction, repurchase frequency of physical goods according to merchant-specific repurchases, repurchase volume of physical goods according to merchant-specific repurchases, volume or revenue of transactions for each physical good, among other data as well as averages, ranges, medians, distributions, frequencies, totals, and seasonalities thereof for each physical goods supplier.

In some embodiments, using the transaction data, the entity classification model engine 130 may determine whether a given entity is a physical goods supplier using the processes described above. For example, the parameters of a classifier of the entity classification model engine 130 may be trained to correlate volumes and frequencies of transactions for particular goods or goods types with an entity being a physical goods supplier. Once an entity is determined to be a physical goods supplier, the entity rating model engine 140 may predict a physical goods supplier rating for each physical goods supplier based on the transaction data and transaction patterns described above. For example, greater frequencies of transactions for physical goods or for repurchases of physical goods may signal high merchant satisfaction with the performance of the physical goods supplier. Thus, the entity rating model engine 140 may implement a machine learning model as described above to predict the rating for a particular physical goods supplier based on the transactions and patterns thereof.

As a result, the entity discovery and recommendation system 110 may output an entity rating prediction 305 for one or more physical goods suppliers to recommend to the merchant at the computing device 106 one or more physical goods suppliers based on performance ratings of the physical goods suppliers.

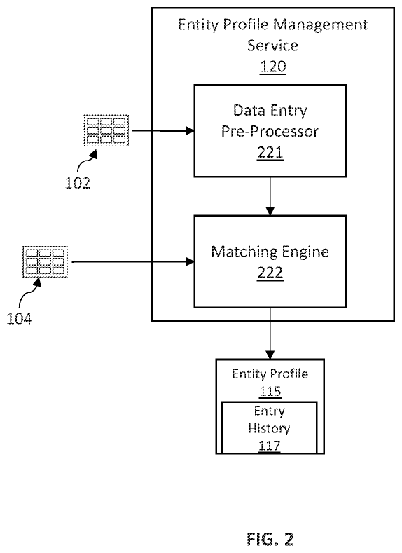

FIG. 2 is a block diagram of an exemplary entity profile management service for automated entity discovery, rating and recommendation in accordance with one or more embodiments of the present disclosure.

In some embodiments, the activity records 102 may be received, e.g., in real-time, in batches, as a continuous stream, or according to any other suitable record communication methodology, via one or more activity execution devices 101a through 101n as described above. In some embodiments, a user may execute electronic activities by employing the one or more activity execution devices 101a through 101n. Activity records 102 of the electronic activities may be communicated to the entity profile management service 120 to compile a set of activity records 102 for each entity. In some embodiments, each activity record 102 may include data identifying an entity with which the user has interacted in executing each electronic activity. Accordingly, the activity records 102 may be matched up to entities recorded in the entity records 104.

In some embodiments, the entity profile management service 120 may include a processor (such as, e.g., processor 111 described above or another processor or combination thereof), such as, e.g., a complex instruction set (CISC) processor such as an x86 compatible processor, or a reduced instruction set (RISC) processor such as an ARM, RISC-V or other instruction set compatible processor, or any other suitable processor including graphical processors, field programmable gate arrays (FPGA), neural processors, etc.

In some embodiments, the processor may be configured to perform instructions provided by, e.g., accessing data stored in a memory. In some embodiments, the memory may include a non-volatile storage device, such as, e.g., a magnetic disk hard drive, a solid state drive, flash memory, or other non-volatile memory and combinations thereof, a volatile memory such as, e.g., random access memory (RAM) including dynamic RAM and/or static RAM, among other volatile memory devices and combinations thereof. In some embodiments, the memory may store data resulting from processing operations, a cache or buffer of data to be used for processing operations, operation logs, error logs, security reports, among other data related to the operation of the entity profile management service 120.

In some embodiments, the activity records 102 include raw data records from the activity execution devices 101a through 101n. As such, the data items from the activity records 102 may include, e.g., a variety of data formats, a variety of data types, unstructured data, duplicate data, among other data variances. Thus, to facilitate processing and using the data for consistent and accurate results, the data may be pre-processed with a data entry pre-processor 221 to remove inconsistencies, anomalies and variances. Thus, in some embodiments, data entry pre-processor 221 may ingest, aggregate, and/or cleanse, among other pre-processing steps and combinations thereof, the data items from each of the activity records 102.

In some embodiments, pre-processing may include compiling the activity records 102 into a single structure, such as, e.g., a single file, a single table, a single list, or other data container having consistent data item types. For example, each data record may be added to, e.g., a table with data items identified for each of, e.g., a date, a first entity, an entity, an activity-related quantity, among other fields. The format of each field may be consistent across all records after pre-processing such that each record has a predictable representation of the data recorded therein.

Similarly, the entity records 104 may be organized according to entity profile 114 through entity profile 115 as described above. For example, each entity record 104 may be added to, e.g., a table, array, file, database object, or other profile structure with data items identified for each of, e.g., an entity, among other fields. The format of each field may be consistent across all records after pre-processing such that each record has a predictable representation of the data recorded therein.

In some embodiments, a matching engine 222 receives the pre-processed activity records 102 from the data entry pre-processor 221 and the entity records 104 from, e.g., the entity profiles and/or the entity recordation system 103 described above. In some embodiments, the entity records 104 may be received, e.g., in real-time, in batches, as a continuous stream, or according to any other suitable record communication methodology.

In some embodiments, based on the data items represented in each of the activity records 102 and the entity records 104, the matching engine 222 may match each entity record 104 to related activity records 102 based on, e.g., similarity. In some embodiments, the matching engine 222 may include, e.g., a memory having instructions stored thereon, as well as, e.g., a buffer to load data and instructions for processing, a communication interface, a controller, among other hardware. A combination of software and/or hardware may then be implemented by the matching engine 222 in conjunction with the processor to implement the instructions stored in the memory.

In some embodiments, similarity or relatedness of the activity records 102 to each entity record 104 may be determined by the matching engine 222 according to a matching algorithm.

In some embodiments, the matching engine 222 utilizes a machine learning model to compare the data items of the activity records 102 with the data items of each entity record 104 to generate a probability of a match. Thus, in some embodiments, the matching engine 222 utilizes, e.g., a classifier to classify entities and matches based on a probability. In some embodiments, the classifier may include, e.g., random forest, gradient boosted machines, neural networks including convolutional neural network (CNN), among others and combinations thereof. Indeed, in some embodiments, a gradient boosted machine of an ensemble of trees is utilized. Such models may capture a non-linear relationship between transactions and merchants, thus providing accurate predictions of matches. In some embodiments, the classifier may be configured to classify a match where the probability of a match exceeds a probability of, e.g., 90%, 95%, 97%, 99% or other suitable probability based on the respective data entity feature vectors.

However, matching the activity records 102 to the associated entity records 104 may be a processor intensive and resource intensive process. To reduce the use of resources, instead or in combination with machine learning, the matching engine 222 may compare the first data entity feature vectors with each second data entity feature vector using, e.g., a Heuristic search, a Euclidean distance, a Cosine Similarity, a Pearson's Correlation Coefficient, a Jaccard Similarity, or other similarity algorithm.

In some embodiments, for example, the matching engine 222 may match activity records 102 to each entity record 104 using, e.g., a heuristic search. In some embodiments, the heuristic search may compare each activity record 102 to each entity record 104 to compare, e.g., an entity identifier data item of a particular activity record 102 to an entity identifier data item a particular entity record 104 and determines potential matches based on the distance of pairs of values representing the respective entity identifiers. Other or additionally data items of each of the activity records 102 and the entity records 104 may be incorporated to determine potential matches.

In some embodiments, each activity record 102 matching to an entity record 104 may be added or appended to the corresponding entity profile 115 in a log of an activity history 117 recording entity-related activity records.

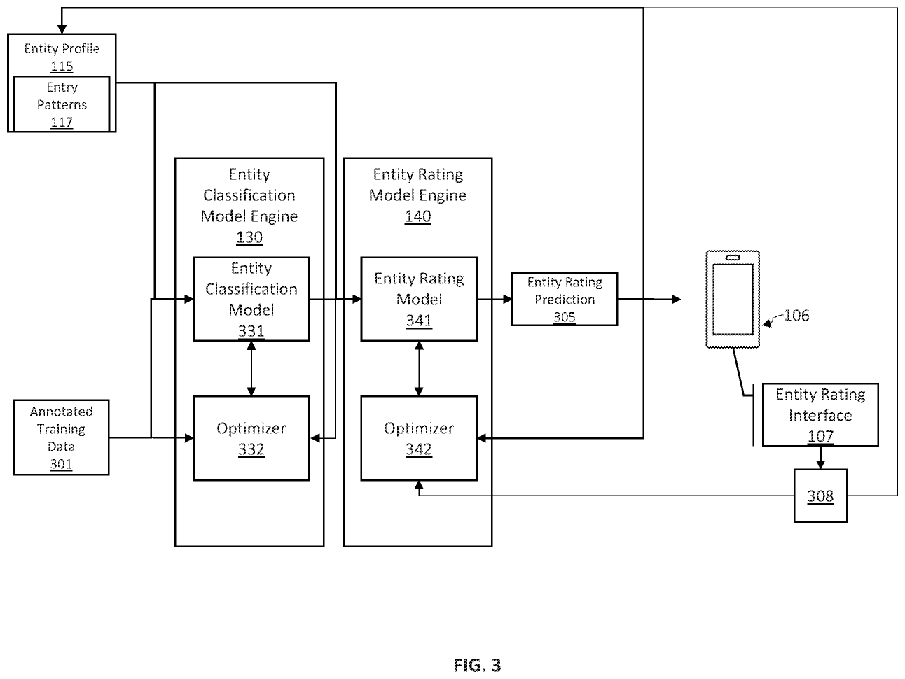

FIG. 3 is a block diagram of an exemplary machine learning architecture for automated entity discovery, rating and recommendation in accordance with one or more embodiments of the present disclosure.

In some embodiments, the entity classification model engine 130 may access, receive or otherwise obtain the activity history 117 of the entity profile 115 from the entity profile management service 120. An entity classification model 331 of the entity classification model engine 130 may be defined to allow to generate an entity type classification based on data regarding electronic activities from the activity records in the activity history 117.

In some embodiments, to ingest the data of each activity record, the entity classification model engine 130 may extract attributes and characteristics to formulate features for use in the entity classification model to identify an entity type according to the electronic activities in which with the entity participates.

Accordingly, in some embodiments, the entity classification model engine 130 may extract data items such as, e.g., a user identifier associated with each data entry, a third-party entity identifier associated with each data entry, an activity type identifier, an activity value or activity quantity, a time data item, a location data item, a date data item, a device type or device identifier associated with the activity execution network 101, an activity description, or other attributes representing characteristics of each data entry. For example, in some embodiments, the entity classification model engine 130 may examine metadata associated with each activity record 102 to identify, e.g., location, date, time, entity or device identifiers, entity and/or device type, a value or quantity, an activity operation and/or operation type, an activity type or category, associated data fraud or security checks among other attributes and characteristics associated with the electronic activity. However, in some embodiments, one or more of the attributes and characteristics may be explicitly specified in the activity record 102 or, e.g., in the entity profile 115. In some embodiments, the activity record 102 may each also specify, e.g., the user identifier, third-party entity identifier, the activity value or activity quantity, the activity type, the activity operation, among other data attributes and characteristics and combinations thereof.

In some embodiments, the entity classification model engine 130 may generate features based on the data items extracted from the activity records. For example, the features may include, e.g., average activity frequency, average activity volume (e.g., account to activity quantity or activity value), seasonal changes to average activity frequency or volume, average activity frequency per activity category, average activity volume (e.g., account to activity quantity or activity value) per activity category, seasonal changes to average activity frequency or volume per activity category, among other features. In some embodiments, the entity classification model engine 130 may encode the features extracted from activity records into a feature vector. In some embodiments, the feature vector may include a one-dimensional vector of values representing each extracted feature. Accordingly, the feature vector may be efficiently ingested by a machine learning model for prediction.

In some embodiments, the entity classification model 331 may generate a prediction for an entity type based on the feature vector associated with an entity of the entity profile 115. In some embodiments, the entity classification model 331 utilized classification parameters trained using an optimizer 332 and annotated training data. In some embodiments, the annotated training data 301 may include, e.g., human labelled activity records that are annotated according to entity type for the entity associated with each human labelled activity record. In some embodiments, the entity classification model 331 generates a prediction for each human labelled activity record and the optimizer 332 compares the annotation of each human labelled activity record with each prediction for each human labelled activity record. Based on a difference between the annotation and the prediction for each human labelled activity record in the annotated training data 301, the optimizer 332 determines a loss according to a suitable loss function. In some embodiments, the optimizer 332 may employ a loss function, such as, e.g., Hinge Loss, Multi-class SVM Loss, Cross Entropy Loss, Negative Log Likelihood, or other suitable classification loss function. In some embodiments, the optimizer 332 may, e.g., backpropagate the error to the entity classification model 331 to update the classification parameters using, e.g., gradient descent, heuristic, convergence or other optimization techniques and combinations thereof.

Accordingly, the entity classification model 331 may ingest the feature vector for the activity records of the activity history 117 to determine a prediction for the entity type of the entity associated with the entity profile 115 based on the classification parameters.

In some embodiments, the entity rating model engine 140 may access, receive or otherwise obtain the activity history 117 of the entity profile 115 from the entity profile management service 120. An entity classification model 331 of the entity rating model engine 140 may generate an entity type classification based on data regarding electronic activities from the activity records in the activity history 117.

In some embodiments, to ingest the data of each activity record, the entity rating model engine 140 may extract attributes and characteristics to formulate features for use in the entity classification model to identify an entity type according to the electronic activities in which with the entity participates.

Accordingly, in some embodiments, the entity rating model engine 140 may extract data items such as, e.g., a user identifier associated with each data entry, a third-party entity identifier associated with each data entry, an activity type identifier, an activity value or activity quantity, a time data item, a location data item, a date data item, a device type or device identifier associated with the activity execution network 101, an activity description, or other attributes representing characteristics of each data entry. For example, in some embodiments, the entity rating model engine 140 may examine metadata associated with each activity record 102 to identify, e.g., location, date, time, entity or device identifiers, entity and/or device type, a value or quantity, an activity operation and/or operation type, an activity type or category, associated data fraud or security checks among other attributes and characteristics associated with the electronic activity. However, in some embodiments, one or more of the attributes and characteristics may be explicitly specified in the activity record 102 or, e.g., in the entity profile 115. In some embodiments, the activity record 102 may each also specify, e.g., the user identifier, third-party entity identifier, the activity value or activity quantity, the activity type, the activity operation, among other data attributes and characteristics and combinations thereof.

In some embodiments, the entity rating model engine 140 may also extract entity-related activity characteristics from the activity history 117. In some embodiments, the entity-related activity characteristics may be determined from the data items of each activity record 102 in the activity history, or may be predefined in the entity profile 115, e.g., by the entity profile management service 120 as described above. In some embodiments, the activity-related activity characteristics may include, e.g., entity-related activity patterns, such as those described above, including, e.g., average activity frequency, average activity volume (e.g., account to activity quantity or activity value), seasonal changes to average activity frequency or volume, average activity frequency per activity category, average activity volume (e.g., account to activity quantity or activity value) per activity category, seasonal changes to average activity frequency or volume per activity category, among other features. In some embodiments, the entity rating model engine 140 may generate from the entity-related activity characteristics features representing the entity-related activity characteristics.

However, in some embodiments, other entity-related activity characteristics may influence activity volumes, activity quantities, activity values and repeat rates, such as seasonality, the type or category of the other entities, and other externalities. For example, the other entity may have a particular type or category that affects the electronic activities of the activity records 102. Thus, a category code signifying the type or category of the other entity may signal the performance, the quality and/or the satisfaction rates for executing electronic activities with the other entities having the same category code.

In some embodiments, the entity rating model engine 140 may customize the entity rating prediction 305 for a user requesting the entity rating prediction 305, e.g., from computing device 106. In some embodiments, the user may be associated with the other entity or a second entity that engages in electronic activities with the entity for which the entity rating prediction 305 is requested. Alternatively, or in addition, the user may specify a category code associated with the electronic activities, the other or second entity, or both. Accordingly, the category code of the other entity or second entity associated with the user may be included with the features to inform the prediction.

As a result, the entity rating prediction 305 may be personalized to the user. In some embodiments, the entity rating model engine 140 may encode the features into a feature vector. In some embodiments, the feature vector may include a one-dimensional vector of values representing each extracted feature. Accordingly, the feature vector may be efficiently ingested by a machine learning model for prediction.

In some embodiments, the entity rating model 341 may generate a prediction for an entity rating based on the feature vector associated with an entity of the entity profile 115. In some embodiments, the entity rating may be based on existing entity ratings of other entity profiles. Accordingly, in some embodiments, the entity rating model 341 may include, for example, without limitation, an entity rating classier model and/or entity rating clustering model to categorize the entity with other entities having similar entity-related activity characteristics, including similar entity-related activity patterns. In some embodiments, the entity rating clustering model may be employed to facilitate unsupervised or semi-supervised learning, thus mitigating a need for lengthy and resource intensive training.

In some embodiments, the entity rating model 341 (e.g., entity rating classifier model or entity rating clustering model) may ingest the feature vector for the entity-related activity characteristics. Using trained parameters, the entity rating model 341 may produce, based on the entity-related activity characteristics, an entity rating prediction 305 signifying a performance rating of the entity in performing electronic activities executed via the activity execution network 101.

In some embodiments, the entity rating prediction 305 may include a rating category including, e.g., a whole number from, e.g., 1 to 5, 1 to 10, 1 to 20, 1 to 100, or any other suitable numerical scale, or a qualitative term including, e.g., low/medium/high, bad/fair/good/better/best, below average/average/above average/exceptional, or any other qualitative scale. In some embodiments, the entity rating prediction 305 may be appended to the entity profile 115 of the associated entity, and/or provided directly to a user at the computing device 106.

In some embodiments, the entity rating model engine 140 may return the entity rating prediction 305 to the computing device 106, e.g., in response to a request from the computing device 106. In some embodiments, a user may interact with an entity rating interface 107 to request, e.g., in response to a request by the user via the entity rating interface 107 for a rating prediction for a particular entity, the entity rating prediction 305 from the entity rating model engine 140. Accordingly, the user may select an entity, or an entity type and be quickly and efficiently provided with rating predictions for the selected entity or a recommended set of the highest performing entities for the selected type, thus improving entity discovery, entity rating, entity recommendation and other functionalities with dynamic and personalized predictions.

In some embodiments, the user may respond to the entity rating prediction 305 to, e.g., modify the entity rating prediction 305. In some embodiments, the entity rating interface 107 may include options for user selection that enable the user to select a correction, adjustment, modification or confirmation of the entity rating prediction 305, such as, e.g., user selection of a different rating value or classification, user selection of a confirmation, user inaction including not selecting a correction, adjustment or modification, or other form of modification. In some embodiments, the modification may be returned to an optimizer 342 of the entity rating model engine 140 as an entity rating prediction modification 308. In some embodiments, the optimizer 342 may utilize the entity rating prediction modification 308 to train the entity rating model 341 according to a difference between the entity rating prediction 305 and the entity rating prediction modification 308.

In some embodiments, the entity rating model 341 utilized rating parameters trained using the optimizer 342 and the user specified entity rating prediction modification 308. For example, an entity rating classifier model may utilize rating classification parameters, while an entity rating clustering model may utilize rating clustering parameters. The optimizer 342 compares the entity rating prediction modification 308 with the corresponding entity rating prediction 305. Based on a difference between the entity rating prediction modification 308 and the entity rating prediction 305, the optimizer 342 determines a loss according to a suitable loss function. In some embodiments, the optimizer 342 may employ a loss function, such as, e.g., Hinge Loss, Multi-class SVM Loss, Cross Entropy Loss, Negative Log Likelihood, or other suitable classification loss function. In some embodiments, the optimizer 342 may, e.g., backpropagate the error to the entity rating model 341 to update the rating parameters using, e.g., gradient descent, heuristic, convergence or other optimization techniques and combinations thereof.

In some embodiments, as more users modify the entity rating prediction for a particular entity, an entity performance rating may be formed in the entity profile 115 that includes the entity rating prediction 305 replaced with a statistical aggregation of the modifications to the entity rating. In some embodiments, rather than replacing the entity rating prediction 305, the modifications to the entity rating may be used to augment the entity rating prediction 305, e.g., using a statistical aggregation of the modifications to the entity rating prediction and the entity rating prediction 305 to produce the entity performance rating. In some embodiments, the entity rating interface 107 may display the entity performance rating using, e.g., the entity rating prediction 305 for the requesting user aggregated with the modifications to the entity rating predictions for previous requesting users.

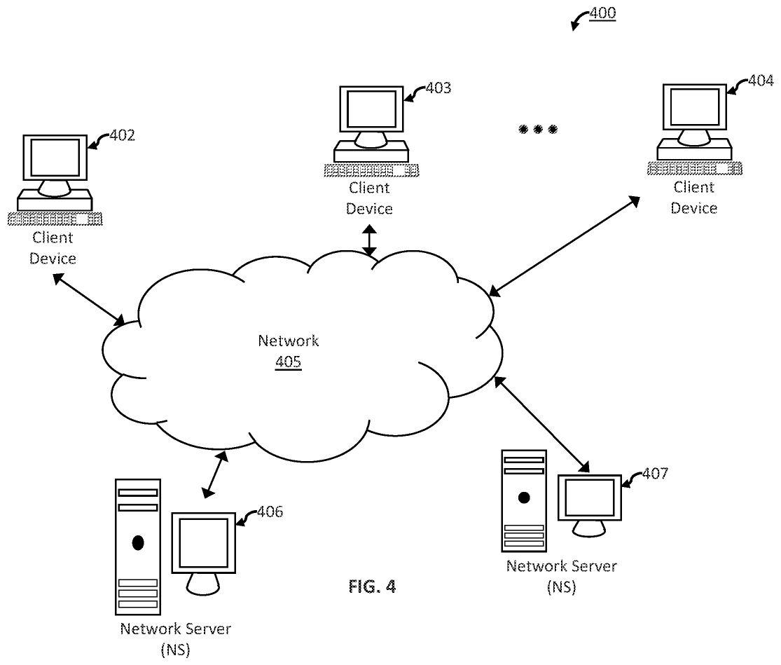

FIG. 4 depicts a block diagram of an exemplary computer-based system and platform 400 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the illustrative computing devices and the illustrative computing components of the exemplary computer-based system and platform 400 may be configured to manage a large number of members and concurrent transactions, as detailed herein. In some embodiments, the exemplary computer-based system and platform 400 may be based on a scalable computer and network architecture that incorporates varies strategies for assessing the data, caching, searching, and/or database connection pooling. An example of the scalable architecture is an architecture that is capable of operating multiple servers.

In some embodiments, referring to FIG. 4, member computing device 402, member computing device 403 through member computing device 404 (e.g., clients) of the exemplary computer-based system and platform 400 may include virtually any computing device capable of receiving and sending a message over a network (e.g., cloud network), such as network 405, to and from another computing device, such as servers 406 and 407, each other, and the like. In some embodiments, the member devices 402-404 may be personal computers, multiprocessor systems, microprocessor-based or programmable consumer electronics, network PCs, and the like. In some embodiments, one or more member devices within member devices 402-404 may include computing devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile computing device, and the like. In some embodiments, one or more member devices within member devices 402-404 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, satellite, ZigBee, etc.). In some embodiments, one or more member devices within member devices 402-404 may include may run one or more applications, such as Internet browsers, mobile applications, voice calls, video games, videoconferencing, and email, among others. In some embodiments, one or more member devices within member devices 402-404 may be configured to receive and to send web pages, and the like. In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a member device within member devices 402-404 may be specifically programmed by either Java, .Net, QT, C, C++ and/or other suitable programming language. In some embodiments, one or more member devices within member devices 402-404 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, the exemplary network 405 may provide network access, data transport and/or other services to any computing device coupled to it. In some embodiments, the exemplary network 405 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 405 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 405 may include and implement, as an alternative or in conjunction with one or more of the above, a WiMAX architecture defined by the WiMAX forum. In some embodiments and, optionally, in combination of any embodiment described above or below, the exemplary network 405 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 405 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, satellite and any combination thereof. In some embodiments, the exemplary network 405 may also include mass storage, such as network attached storage (NAS), a storage area network (SAN), a content delivery network (CDN) or other forms of computer or machine readable media.

In some embodiments, the exemplary server 406 or the exemplary server 407 may be a web server (or a series of servers) running a network operating system, examples of which may include but are not limited to Microsoft Windows Server, Novell NetWare, or Linux. In some embodiments, the exemplary server 406 or the exemplary server 407 may be used for and/or provide cloud and/or network computing. Although not shown in FIG. 4, in some embodiments, the exemplary server 406 or the exemplary server 407 may have connections to external systems like email, SMS messaging, text messaging, ad content providers, etc. Any of the features of the exemplary server 406 may be also implemented in the exemplary server 407 and vice versa.

In some embodiments, one or more of the exemplary servers 406 and 407 may be specifically programmed to perform, in non-limiting example, as authentication servers, search servers, email servers, social networking services servers, SMS servers, IM servers, MMS servers, exchange servers, photo-sharing services servers, advertisement providing servers, financial/banking-related services servers, travel services servers, or any similarly suitable service-base servers for users of the member computing devices 401-404.

In some embodiments and, optionally, in combination of any embodiment described above or below, for example, one or more exemplary computing member devices 402-404, the exemplary server 406, and/or the exemplary server 407 may include a specifically programmed software module that may be configured to send, process, and receive information using a scripting language, a remote procedure call, an email, a tweet, Short Message Service (SMS), Multimedia Message Service (MMS), instant messaging (IM), internet relay chat (IRC), mIRC, Jabber, an application programming interface, Simple Object Access Protocol (SOAP) methods, Common Object Request Broker Architecture (CORBA), HTTP (Hypertext Transfer Protocol), REST (Representational State Transfer), or any combination thereof.

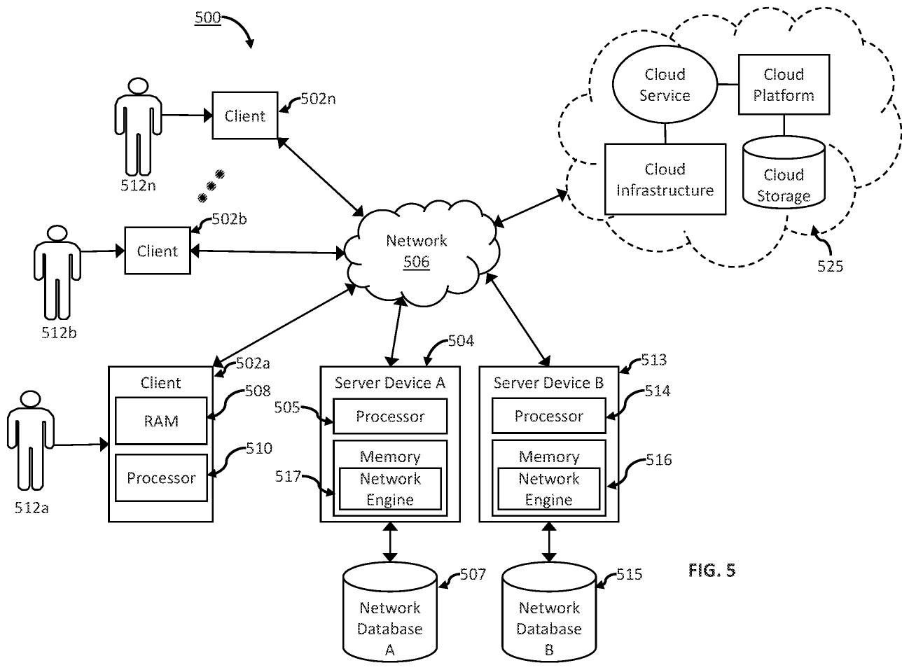

FIG. 5 depicts a block diagram of another exemplary computer-based system and platform 500 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the member computing device 502a, member computing device 502b through member computing device 502n shown each at least includes a computer-readable medium, such as a random-access memory (RAM) 508 coupled to a processor 510 or FLASH memory. In some embodiments, the processor 510 may execute computer-executable program instructions stored in memory 508. In some embodiments, the processor 510 may include a microprocessor, an ASIC, and/or a state machine. In some embodiments, the processor 510 may include, or may be in communication with, media, for example computer-readable media, which stores instructions that, when executed by the processor 510, may cause the processor 510 to perform one or more steps described herein. In some embodiments, examples of computer-readable media may include, but are not limited to, an electronic, optical, magnetic, or other storage or transmission device capable of providing a processor, such as the processor 510 of member computing device 502a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, member computing devices 502a through 502n may also comprise a number of external or internal devices such as a mouse, a CD-ROM, DVD, a physical or virtual keyboard, a display, or other input or output devices. In some embodiments, examples of member computing devices 502a through 502n (e.g., clients) may be any type of processor-based platforms that are connected to a network 506 such as, without limitation, personal computers, digital assistants, personal digital assistants, smart phones, pagers, digital tablets, laptop computers, Internet appliances, and other processor-based devices. In some embodiments, member computing devices 502a through 502n may be specifically programmed with one or more application programs in accordance with one or more principles/methodologies detailed herein. In some embodiments, member computing devices 502a through 502n may operate on any operating system capable of supporting a browser or browser-enabled application, such as Microsoft™ Windows™, and/or Linux. In some embodiments, member computing devices 502a through 502n shown may include, for example, personal computers executing a browser application program such as Microsoft Corporation's Internet Explorer™, Apple Computer, Inc.'s Safari™, Mozilla Firefox, and/or Opera. In some embodiments, through the member computing client devices 502a through 502n, user 512a, user 512b through user 512n, may communicate over the exemplary network 506 with each other and/or with other systems and/or devices coupled to the network 506.

As shown in FIG. 5, exemplary server devices 504 and 513 may include processor 505 and processor 514, respectively, as well as memory 517 and memory 516, respectively. In some embodiments, the server devices 504 and 513 may be also coupled to the network 506. In some embodiments, one or more member computing devices 502a through 502n may be mobile clients.

In some embodiments, at least one database of exemplary databases 507 and 515 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

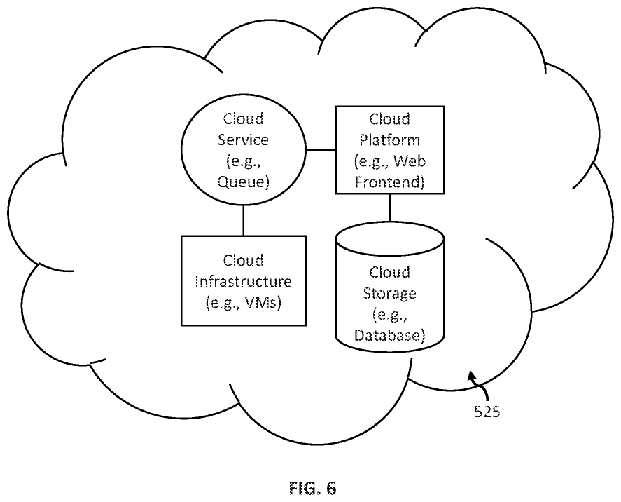

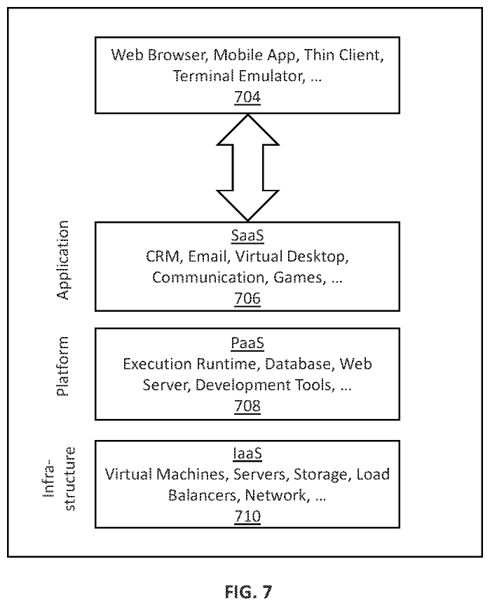

In some embodiments, the exemplary inventive computer-based systems/platforms, the exemplary inventive computer-based devices, and/or the exemplary inventive computer-based components of the present disclosure may be specifically configured to operate in a cloud computing/architecture 525 such as, but not limiting to: infrastructure a service (IaaS) 710, platform as a service (PaaS) 708, and/or software as a service (SaaS) 706 using a web browser, mobile app, thin client, terminal emulator or other endpoint 704. FIGS. 6 and 7 illustrate schematics of exemplary implementations of the cloud computing/architecture(s) in which the exemplary inventive computer-based systems/platforms, the exemplary inventive computer-based devices, and/or the exemplary inventive computer-based components of the present disclosure may be specifically configured to operate.

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

As used herein, the term “runtime” corresponds to any behavior that is dynamically determined during an execution of a software application or at least a portion of software application.

In some embodiments, exemplary inventive, specially programmed computing systems and platforms with associated devices are configured to operate in the distributed network environment, communicating with one another over one or more suitable data communication networks (e.g., the Internet, satellite, etc.) and utilizing one or more suitable data communication protocols/modes such as, without limitation, IPX/SPX, X.25, AX.25, AppleTalk™, TCP/IP (e.g., HTTP), near-field wireless communication (NFC), RFID, Narrow Band Internet of Things (NBIOT), 3G, 4G, 5G, GSM, GPRS, WiFi, WiMax, CDMA, satellite, ZigBee, and other suitable communication modes.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

As used herein, the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

As used herein, the terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

In some embodiments, as detailed herein, one or more of the computer-based systems of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a message, a map, an entire application (e.g., a calculator), data points, and other suitable data. In some embodiments, as detailed herein, one or more of the computer-based systems of the present disclosure may be implemented across one or more of various computer platforms such as, but not limited to: (1) Linux, (2) Microsoft Windows, (3) OS X (Mac OS), (4) Solaris, (5) UNIX (6) VMWare, (7) Android, (8) Java Platforms, (9) Open Web Platform, (10) Kubernetes or other suitable computer platforms. In some embodiments, illustrative computer-based systems or platforms of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, illustrative computer-based systems or platforms of the present disclosure may be configured to handle numerous concurrent users that may be, but is not limited to, at least 100 (e.g., but not limited to, 100-999), at least 1,000 (e.g., but not limited to, 1,000-9,999), at least 10,000 (e.g., but not limited to, 10,000-99,999), at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-999,999,999,999), and so on.

In some embodiments, illustrative computer-based systems or platforms of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, or objects. For example, such projections may be a visual overlay for a mobile augmented reality (MAR) application.

As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™, Pager, Smartphone, or any other reasonable mobile electronic device.

In some embodiments, the illustrative computer-based systems or platforms of the present disclosure may be configured to securely store and/or transmit data by utilizing one or more of encryption techniques (e.g., private/public key pair, Triple Data Encryption Standard (3DES), block cipher algorithms (e.g., IDEA, RC2, RCS, CAST and Skipjack), cryptographic hash algorithms (e.g., MD5, RIPEMD-160, RTR0, SHA-1, SHA-2, Tiger (TTH), WHIRLPOOL, RNGs).

As used herein, the term “user” shall have a meaning of at least one user. In some embodiments, the terms “user”, “subscriber” “consumer” or “customer” should be understood to refer to a user of an application or applications as described herein, and/or a consumer of data supplied by a data provider. By way of example, and not limitation, the terms “user” or “subscriber” can refer to a person who receives data provided by the data or service provider over the Internet in a browser session or can refer to an automated software application which receives the data and stores or processes the data.

The aforementioned examples are, of course, illustrative and not restrictive.

At least some aspects of the present disclosure will now be described with reference to the following numbered clauses.

1. A method comprising:

receiving, by at least one processor, activity records associated with a plurality of entities;
wherein the activity records comprise activity data for electronic activities with the plurality of entities;

utilizing, by the at least one processor, an entity classification model engine to predict at least one entity-type classification classifying at least one first entity of the plurality of entities as a first entity type;
wherein the entity classification model engine comprises an entity classification model that comprises a plurality of classification parameters trained based on a plurality of annotated training activity records;

extracting, by the at least one processor, a first plurality of entity-related activity characteristics associated with the at least one first entity from the activity data;
wherein the first plurality of entity-related activity characteristics represents a first entity-related activity pattern of activities across the activity data;

utilizing, by the at least one processor, an entity rating model engine, comprising an entity rating model, to predict at least one entity rating prediction for the at least one entity based at least in part on the entity-related activity pattern;
wherein the entity rating model engine comprises a plurality of trained rating parameters trained based on at least one historical entity rating prediction for the plurality of entities;
generating, by the at least one processor, an entity rating interface comprising the at least one entity rating prediction interface element for the at least one entity;
wherein the entity rating interface comprises:
   i) at least one first interface programmed element that enables a user to define at least one entity rating prediction modification so as cause the at least one processor to modify the at least one entity rating prediction to obtain at least one updated entity rating prediction, and
   ii) at least one second interface programmed element that displays the at least one updated entity rating prediction; and

causing to display, by the at least one processor, the entity rating interface on a display of at least one computing device associated with at least one user.

2. A method comprising:

receiving, by at least one processor via an entity rating interface, a user selection of an entity rating prediction modification for an entity rating prediction interface element of at least one entity;
wherein the entity rating interface comprises:
   i) at least one first interface programmed element that enables a user to define the at least one entity rating prediction modification so as cause the at least one processor to modify at least one entity rating prediction to obtain at least one updated entity rating prediction, and
   ii) at least one second interface programmed element that displays the at least one updated entity rating prediction;

extracting, by the at least one processor, entity-related activity characteristics associated with the at least one entity from activity records associated with the at least one entity;
wherein the activity records comprise activity data for electronic activities associated with the at least one entity;
wherein the entity-related activity characteristics comprise entity-related activity pattern of activities across the activity data;

training, by the at least one processor, plurality of trained rating parameters of an entity rating model engine based on a difference between the entity-related activity pattern and the at least one entity rating prediction modification;

utilizing, by the at least one processor, an entity rating model engine to predict at least one entity rating prediction for the at least one entity based at least in part on the entity-related activity pattern;
wherein the entity rating model engine comprises plurality of trained rating parameters trained based on historical entity rating predictions for a plurality of entities;

updating, by the at least one processor, the entity rating interface comprising the at least one entity rating prediction for the at least one entity; and

causing to display, by the at least one processor, the entity rating interface on a display of at least one computing device associated with at least one user.

3. A system comprising:

at least one processor in communication with at least one non-transitory computer readable medium comprising software instructions that, when executed, cause the at least one processor to perform steps to:
receive activity records associated with a plurality of entities;
   wherein the activity records comprise activity data for electronic activities with the plurality of entities;
utilize an entity classification model engine to predict at least one entity-type classification classifying at least one entity of the plurality of entities as a first entity type;
   wherein the entity classification model engine comprises a plurality of classification parameters trained based on plurality of annotated training activity records;
extract entity-related activity characteristics associated with the at least one entity from the activity data;
   wherein the entity-related activity characteristics represent an entity-related activity pattern of activities across the activity data;
utilize an entity rating model engine to predict at least one entity rating prediction for the at least one entity based at least in part on the entity-related activity pattern;
   wherein the entity rating model engine comprises plurality of trained rating parameters trained based on historical entity rating predictions for the plurality of entities;
generate an entity rating interface comprising the at least one entity rating prediction for the at least one entity;
   wherein the entity rating interface is configured to:
      i) enable a user to define at least one entity rating prediction modification so as cause the at least one processor to modify the at least one entity rating prediction to obtain at least one updated entity rating prediction, and
      ii) display the at least one updated entity rating prediction; and
cause to display the entity rating interface on a display of at least one computing device associated with at least one user.
   4. The methods and systems of any of clauses 1 through 3, further comprising:

receiving, by the at least one processor, enhanced activity data associated with the activity data of the activity records; and
wherein the enhanced activity data is provided by an activity data enrichment service;
wherein the entity-related activity characteristics comprise the entity-related activity pattern of activities associated with the activity data and the enhanced activity data.
   5. The methods and systems of any of clauses 1 through 3, wherein the activity records comprise transaction authorization request messages.
   6. The methods and systems of 5, wherein the first entity type comprises a physical goods supplier.
   7. The methods and systems of 6, wherein the entity-related activity pattern of activities of the activity data associated with the physical goods supplier comprises:

i) a repurchase rate by each second entity of a plurality of second entities that purchase from the physical goods supplier,

ii) a seasonality of purchases by each second entity of the plurality of second entities that purchase from the physical goods supplier,

iii) a transaction volume by each second entity of the plurality of second entities that purchase from the physical goods supplier, and

iv) a type of goods by each second entity of the plurality of second entities that purchase from the physical goods supplier.

8. The methods and systems of any of clauses 1 through 3, further comprising:

determining, by the at least one processor, a category code associated with the at least one entity; and

utilizing, by the at least one processor, the entity rating model engine to predict the at least one entity rating prediction for the at least one entity based at least in part on the entity-related activity pattern and the category code.

9. The methods and systems of any of clauses 1 through 3, further comprising:

receiving, by the at least one processor, a user selection of the at least one entity rating prediction modification for the at least one entity to obtain the at least one updated entity rating prediction; and

training, by the at least one processor, the plurality of trained rating parameters of the entity rating model engine based on a difference between the at least one entity rating prediction and the at least one updated entity rating prediction.

10. The methods and systems of 9, further comprising updating, by the at least one processor, the entity rating interface to represent the at least one updated entity rating prediction.
11. The methods and systems of any of clauses 1 through 3, further comprising:

receiving, by the at least one processor, a category code associated with a second entity; and

utilizing, by the at least one processor, the entity rating model engine to predict, for the second entity, the at least one entity rating prediction of the at least one entity based at least in part on the entity-related activity pattern and the category code so as to customize the at least one entity rating prediction of the at least one entity for the category code of the second entity.

While one or more embodiments of the present disclosure have been described, it is understood that these embodiments are illustrative only, and not restrictive, and that many modifications may become apparent to those of ordinary skill in the art, including that various embodiments of the inventive methodologies, the illustrative systems and platforms, and the illustrative devices described herein can be utilized in any combination with each other. Further still, the various steps may be carried out in any desired order (and any desired steps may be added, and/or any desired steps may be eliminated).

What is claimed is:

1. A method comprising:
receiving, by at least one processor, activity records associated with a plurality of entities;
wherein the activity records comprise activity data for electronic activities with the plurality of entities;
utilizing, by the at least one processor, an entity classification model engine to predict at least one entity-type classification classifying at least one first entity of the plurality of entities as a first entity type;
wherein the entity classification model engine comprises an entity classification model that comprises a plurality of classification parameters trained based on a plurality of annotated training activity records;
extracting, by the at least one processor, a first plurality of entity-related activity characteristics associated with the at least one first entity from the activity data;
wherein the first plurality of entity-related activity characteristics represents a first entity-related activity pattern of activities across the activity data;
utilizing, by the at least one processor, an entity rating model engine, comprising an entity rating model, to predict at least one entity rating prediction for the at least one entity based at least in part on the entity-related activity pattern;
wherein the entity rating model engine comprises a plurality of trained rating parameters trained based on at least one historical entity rating prediction for the plurality of entities;
generating, by the at least one processor, an entity rating interface comprising the at least one entity rating prediction interface element for the at least one entity;
wherein the entity rating interface comprises:
i) at least one first interface programmed element that enables a user to define at least one entity rating prediction modification so as cause the at least one processor to modify the at least one entity rating prediction to obtain at least one updated entity rating prediction, and
ii) at least one second interface programmed element that displays the at least one updated entity rating prediction; and
causing to display, by the at least one processor, the entity rating interface on a display of at least one computing device associated with at least one user.

2. The method of claim 1, further comprising:
receiving, by the at least one processor, enhanced activity data associated with the activity data of the activity records; and
wherein the enhanced activity data is provided by an activity data enrichment service;
wherein the entity-related activity characteristics comprise the entity-related activity pattern of activities associated with the activity data and the enhanced activity data.

3. The method of claim 1, wherein the activity records comprise transaction authorization request messages.

4. The method of claim 3, wherein the first entity type comprises a physical goods supplier.

5. The method of claim 4, wherein the entity-related activity pattern of activities of the activity data associated with the physical goods supplier comprises:
i) a repurchase rate by each second entity of a plurality of second entities that purchase from the physical goods supplier,
ii) a seasonality of purchases by each second entity of the plurality of second entities that purchase from the physical goods supplier,
iii) a transaction volume by each second entity of the plurality of second entities that purchase from the physical goods supplier, and
iv) a type of goods by each second entity of the plurality of second entities that purchase from the physical goods supplier.

6. The method of claim 1, further comprising:
determining, by the at least one processor, a category code associated with the at least one entity; and
utilizing, by the at least one processor, the entity rating model engine to predict the at least one entity rating prediction for the at least one entity based at least in part on the entity-related activity pattern and the category code.

7. The method of claim 1, further comprising:
receiving, by the at least one processor, a user selection of the at least one entity rating prediction modification for the at least one entity to obtain the at least one updated entity rating prediction; and
training, by the at least one processor, the plurality of trained rating parameters of the entity rating model engine based on a difference between the at least one entity rating prediction and the at least one updated entity rating prediction.

8. The method of claim 7, further comprising updating, by the at least one processor, the entity rating interface to represent the at least one updated entity rating prediction.

9. The method of claim 1, further comprising:
receiving, by the at least one processor, a category code associated with a second entity; and
utilizing, by the at least one processor, the entity rating model engine to predict, for the second entity, the at least one entity rating prediction of the at least one entity based at least in part on the entity-related activity pattern and the category code so as to customize the at least one entity rating prediction of the at least one entity for the category code of the second entity.

10. A method comprising:
receiving, by at least one processor via an entity rating interface, a user selection of an entity rating prediction modification for an entity rating prediction interface element of at least one entity;
wherein the entity rating interface comprises:
i) at least one first interface programmed element that enables a user to define the at least one entity rating prediction modification so as cause the at least one processor to modify at least one entity rating prediction to obtain at least one updated entity rating prediction, and
ii) at least one second interface programmed element that displays the at least one updated entity rating prediction;
extracting, by the at least one processor, entity-related activity characteristics associated with the at least one entity from activity records associated with the at least one entity;
wherein the activity records comprise activity data for electronic activities associated with the at least one entity;
wherein the entity-related activity characteristics comprise entity-related activity pattern of activities across the activity data;
training, by the at least one processor, plurality of trained rating parameters of an entity rating model engine based on a difference between the entity-related activity pattern and the at least one entity rating prediction modification;
utilizing, by the at least one processor, an entity rating model engine to predict at least one entity rating prediction for the at least one entity based at least in part on the entity-related activity pattern;
wherein the entity rating model engine comprises plurality of trained rating parameters trained based on historical entity rating predictions for a plurality of entities;
updating, by the at least one processor, the entity rating interface comprising the at least one entity rating prediction for the at least one entity; and
causing to display, by the at least one processor, the entity rating interface on a display of at least one computing device associated with at least one user.

11. The method of claim 10, further comprising:
receiving, by the at least one processor, enhanced activity data associated with the activity data of the activity records; and
wherein the enhanced activity data is provided by an activity data enrichment service;
wherein the entity-related activity characteristics comprise the entity-related activity pattern of activities associated with the activity data and the enhanced activity data.

12. The method of claim 10, wherein the activity records comprise transaction authorization request messages.

13. The method of claim 12, wherein the at least one entity comprises an entity type comprising a physical goods supplier.

14. The method of claim 13, wherein the entity-related activity pattern of activities of the activity data associated with the physical goods supplier comprises:
i) a repurchase rate by each second entity of a plurality of second entities that purchase from the physical goods supplier,
ii) a seasonality of purchases by each second entity of the plurality of second entities that purchase from the physical goods supplier,
iii) a transaction volume by each second entity of the plurality of second entities that purchase from the physical goods supplier, and
iv) a type of goods by each second entity of the plurality of second entities that purchase from the physical goods supplier.

15. The method of claim 10, further comprising:
determining, by the at least one processor, a category code associated with the at least one entity; and
utilizing, by the at least one processor, the entity rating model engine to predict the at least one entity rating prediction for the at least one entity based at least in part on the entity-related activity pattern and the category code.

16. The method of claim 10, further comprising:
receiving, by the at least one processor, the activity records associated with the at least one entity; and
utilizing, by the at least one processor, an entity classification model engine to predict at least one entity-type classification classifying the at least one entity as a first entity type;
wherein the entity classification model engine comprises a plurality of classification parameters trained based on annotated training activity data.

17. The method of claim 16, further comprising updating, by the at least one processor, the entity rating interface to represent the at least one entity rating prediction the at least one entity rating prediction modification.

18. The method of claim 10, further comprising:
receiving, by the at least one processor, a category code associated with a second entity associated with the activity records; and
utilizing, by the at least one processor, the entity rating model engine to predict, for the second entity, the at least one entity rating prediction of the at least one entity based at least in part on the entity-related activity pattern and the category code so as to customize the at least one entity rating prediction of the at least one entity for the category code of the second entity.

19. A system comprising:
at least one processor in communication with at least one non-transitory computer readable medium comprising software instructions that, when executed, cause the at least one processor to perform steps to:
receive activity records associated with a plurality of entities;
wherein the activity records comprise activity data for electronic activities with the plurality of entities;
utilize an entity classification model engine to predict at least one entity-type classification classifying at least one entity of the plurality of entities as a first entity type;
wherein the entity classification model engine comprises a plurality of classification parameters trained based on plurality of annotated training activity records;
extract entity-related activity characteristics associated with the at least one entity from the activity data;
wherein the entity-related activity characteristics represent an entity-related activity pattern of activities across the activity data;
utilize an entity rating model engine to predict at least one entity rating prediction for the at least one entity based at least in part on the entity-related activity pattern;
wherein the entity rating model engine comprises plurality of trained rating parameters trained based on historical entity rating predictions for the plurality of entities;
generate an entity rating interface comprising the at least one entity rating prediction for the at least one entity;
wherein the entity rating interface is configured to:
i) enable a user to define at least one entity rating prediction modification so as cause the at least one processor to modify the at least one entity rating prediction to obtain at least one updated entity rating prediction, and
ii) display the at least one updated entity rating prediction; and
cause to display the entity rating interface on a display of at least one computing device associated with at least one user.

20. The system of claim 19, wherein the software instructions, when executed, further cause the at least one processor to perform steps to:
receive a user selection of the at least one entity rating prediction modification for the at least one entity to obtain the at least one updated entity rating prediction; and
train the plurality of trained rating parameters of the entity rating model engine based on a difference between the at least one entity rating prediction and the at least one updated entity rating prediction.
